(19) United States
(12) Patent Application Publication
(10) Pub. No.: US 2015/0162710 A1
(43) Pub. Date: Jun. 11, 2015

(54) INSULATION BODY OF A PLUG-IN CONNECTOR

(71) Applicant: Harting Electrnics GmbH, Espelkamp (DE)

(72) Inventors: Stephan Schreier, Rahden (DE); Melanie Genau, Luebbecke (DE)

(73) Assignee: Harting Electronics GmbH, Espelkamp (DE)

(21) Appl. No.: 14/406,599

(22) PCT Filed: Apr. 5, 2013
(86) PCT No.: PCT/DE2013/100124

§ 371 Date: Dec. 9, 2014

(30) Foreign Application Priority Data
Jun. 18, 2012 (DE) 10 2012 105 257.3

(51) Int. Cl. H01R 13/6587; H01R 13/631; H01R 12/72

(52) U.S. Cl. CPC H01R 13/6587; H01R 12/72; H01R 13/631

(57) ABSTRACT

The invention relates to an insulation body of a plug-in connector that consists of a plug body (10), in which contact elements (11) are provided, and which consists of a connection body (20), which in turn has connection elements (21) that can be electrically connected to conductor tracks of a circuit board and/or to individual wires of a multi-wired cable to be connected, wherein the plug body (10) and the connection body (20) can be mated together, as a result of which the contact elements (11) can be electrically contacted with the connection elements (21) of the connection body (20).

The invention relates to an insulation body of a plug-in connector according to the preamble of claim 1.

An insulation body is inserted into a chamber of a plug-in connector housing that is provided for this purpose. As a rule, insulation bodies include receptacles for contact elements, which the wires of a cable to be connected to the plug-in connector are connected to. Alternatively, the contact elements may also be electrically contacted with the conductor tracks of a circuit board.

DE 102010051954 B3 shows a circular plug-in connector, the contact members of which penetrate the plug-in connector over its full length, in order to form on the one hand the plug face and on the other hand the connection region of the plug-in connector. Such contact members are frequently bent and cannot be simply inserted into the insulation body. Therefore, the insulation body often has to be designed to be pivotable, foldable or in multiple parts.

In data transmission technology, insulation bodies with so-called shielding elements are used. The shielding elements are used to shield at least two wires of the cable to be connected—and/or the associated contact elements—electromagnetically against each other.

Such insulation bodies are needed in order to provide multi-pole connectors for analogue or digital data transmission, which can be used in shielded implementations at frequencies of up to 600 MHz or even higher.

In an insulation body of DE 102010051954 B3, the shielding cross is designed as a single metallic component that has to be inserted into the plug-in connector. The insulation body has to present such an opening.

It is the object of the invention to propose an insulation body that can be manufactured in a more cost-effective and simple manner than the variants mentioned above.

The object is achieved by means of the characterising features of claim 1.

Advantageous embodiments of the invention are laid out in the dependent claims.

The insulation body proposed here consists of a plug body and a connection body. In the plug body, the contact elements are arranged that form the so-called plug face of the plug-in connector.

In the connection body, connection elements are provided. The connection elements have a connection region that can be electrically contacted for example by conductor tracks of a circuit board. Preferably, the connection region is then formed as a so-called soldering foot 21a (also referred to as solder pin). However, here too, the SMD or pin-in-hole technology can be used. It is also possible to provide an electric contact of the connection region with a conductor of a cable to be connected.

In known insulation bodies, the plug body and the connection body are formed together in one component. In the case of the insulation body according to the invention, the plug body and the connection body are separate components, When these components are mated with each other, the contact elements of the plug body are electrically contacted with the connection elements of the connection body.

In order to allow the plug body and the connection body to be latched together, suitable latching means are preferably provided. These latching means preferably allow a reversible connection of the plug body and the connection body.

By virtue of the plug body and the connection body being in two parts it becomes possible to reversibly connect the same plug body with different connection bodies. As a result, a plug-in connector having the same plug face can be conditioned on the one hand for a circuit board connection and on the other hand for a cable connection. The connection body can be optimally adapted to the respective area of use and can be implemented for example in an angled or in a straight manner. As a result of the modularity of the connection region as described above, the plug-in connector can be used in a versatile manner.

It may also be advantageous to design the plug body and the connection body so that they can be irreversibly latched together by means of latching means. This is advantageous in order to avoid multiple plugging and thus an increase of the transition resistance.

Preferably, the contact elements are formed to be elongate and are arranged parallel to each other in the plug body. One end of the contact member is provided in the plug region of the plug-in connector and can be connected to a contact element of a counter-plug and/or a socket. The other end of the contact element forms a contact region, which a connection element of the connection body can be electrically contacted with.

Preferably, the connection element is designed as a conductor track that offers a connection region for the contact elements thereof in the direction of the plug body. In the circuit board or cable connection direction, a connection region for a conductor track of a circuit board and/or a wire of a cable to be connected is located on the conductor track.

Advantageously, the conductor track of the connection member is produced using MID technology. MID technology is sufficiently described in DE 102006041610 B3. As a result, there is no limit to the freedom in designing the conductor tracks. The conductor tracks may be formed in such a way that they are particularly suitable for high frequency data transmission. The end-side connection regions following on from the conductor track (for example on the one side a connection socket for the contact elements and on the other side the soldering feet for the circuit board) may continue to be implemented as a metallic element.

In an advantageous embodiment of the invention, the plug body has a shielding element that shields at least two contact elements electromagnetically against each other. As a result, a so-called crosstalk of the signals that are transmitted via the contact elements is prevented.

In a further advantageous embodiment of the invention, the connection body is also provided with a shielding element that shields at least two connection elements electromagnetically against each other.

In a particularly preferred embodiment of the invention, the plug body and the connection body each have a shielding element. In the mated condition of the plug body and the connection body, the shielding elements are in electrical contact with each other. Alternatively, the shielding elements overlap in an axial orientation of the insulation body. As a result of the above measures, the signal integrity of the finished plug-in connector is markedly improved.

Advantageously, the above-described shielding elements are produced using MID technology. As a result, the plug body and the connection body may be produced in one piece in a compact and cost-effective manner.

An embodiment example of the invention is shown in the drawings and will be explained in more detail below, wherein:

FIG. 1 shows a perspective view of a plug body,

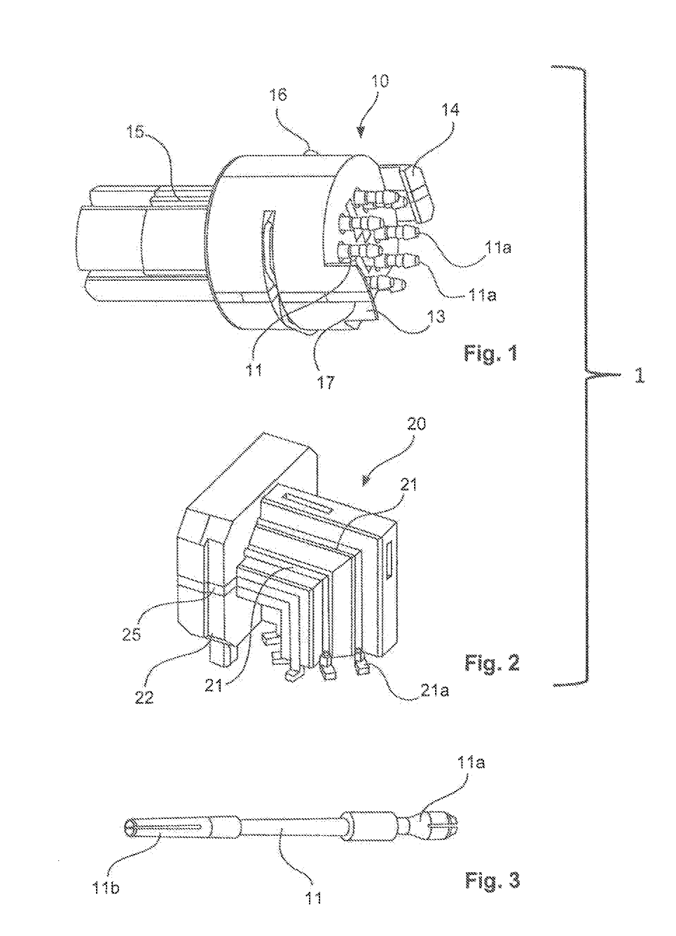

FIG. 2 shows a perspective view of a connection body,

FIG. 3 shows a perspective view of a contact element,

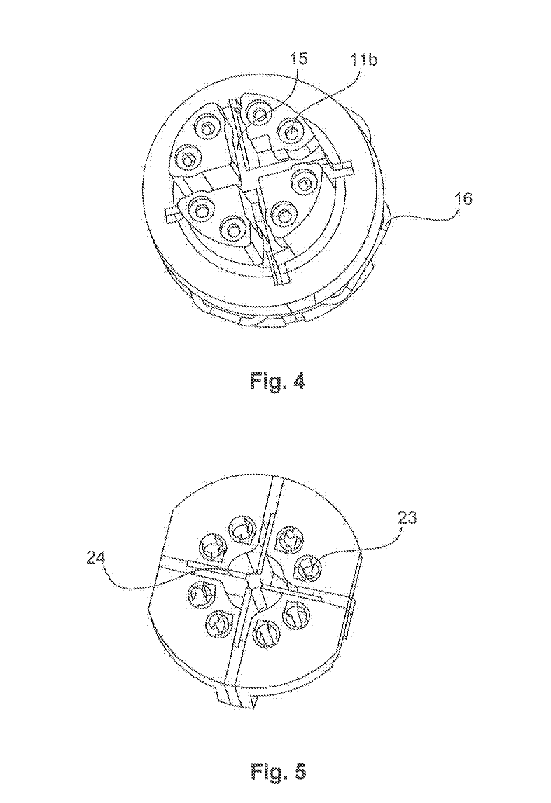

FIG. 4 shows a perspective top view of the plug face of the plug body, and

FIG. 5 shows a further perspective view of the connection body.

FIG. 1 shows a perspective view of a plug body 10 and FIG. 2 shows a perspective view of the associated connection body 20. The plug body 10 and the connection body 20 together form an insulation body 1 for a plug-in connector. In order to lock the plug body 10 and the connection body 20 together, latching arms 13 are provided on the plug body 10, the latching noses 14 of which latching arms engage on an undercut 22 of the connection body 20.

In the plug body 10, contact elements 11 are provided. One end of the contact element 11 can be electrically contacted with the associated connection elements 21 of the connection body 20. To this end, the frustoconical portion 11a is inserted into a contact opening 23 of the connection body 20. The contact opening 23 comprises a conducting material, which in turn is conductively connected to a conductor track 21. The other and is implemented as a bifurcated contact terminal 11b and is provided for contacting contact elements of a counter-plug and/or a socket (not shown). In other embodiments, a simple contact pin instead of the bifurcated contact terminal may be provided in the plug face.

In the plug body 10, a cruciform shielding element 15 is provided, which electromagnetically shields in each case two contact elements 11b in a pairwise manner relative to the other contact elements 11b arranged in a pairwise manner. A metallic shielding spring 16 is in conductive contact with the shielding element 15 and the plug-in connector housing (not shown).

In the connection body 20, too, a cruciform shielding element 24 is provided, which in each case shields two connection elements 21 in a pairwise manner electromagnetically against other connection element pairs.

A conductor track 17, which is connected to the shielding element 15 in a conductive manner, is attached to the latching arm 13 of the plug body 10. Also in the region of the undercut 22 of the connection body 20, a conductor track 25 is applied, which is connected to the shielding element 24. Via the conductor tracks 17, 25, the shielding elements 15, 24 are also contacted in a conductive manner. The conductor tracks 17, 25 are here produced using MID technology.

### LIST OF REFERENCE NUMERALS

1 Insulation body

10 Plug body

Contact element

11a Frustoconical portion

11b Bifurcated contact terminal

13 Latching arm

14 Latching nose

15 Shielding element

16 Shielding spring

17 Conductor track

20 Connection body

21 Connection element

22 Undercut

23 Contact opening

24 Shielding element

25 Conductor track

1. An insulation body of a plug-in connector,
which comprises a plus body (10) wherein contact members (11) are provided,
and which includes a connection body (20) which in turn comprises connection members (21) that can be electrically connected to conductor tracks of a circuit board and/or to individual wires of a multi-wired cable to be connected, characterised in that,
the plug body (10) and the connection body (20) are separate components that can be mated together, as a result of which the contact elements (11) can be electrically contacted with the connection elements (21) of the connection body (20).

2. The insulation body of a plug-in connector as claimed in claim 1,
characterised in that
the plug body (10) includes a shielding element (15) that electromagnetically shields at least two contact elements (11) against each other.

3. The insulation body of plug-in connector as claimed in claim 1,
characterised in that
said connection body (20) includes a shielding element (24) that electromagnetically shields at least two connection members (21) against each other.

4. The insulation body of a plug-in connector as claimed in claim 2,
characterised in that
the shielding elements (15, 24) are produced using MID technology.

5. The insulation body of a plug-in connector as claimed in claim 2,
characterised in that
the shielding elements (15, 24) are electrically contacted with each other and/or overlap in the axial direction.

6. The insulation body of a plug-in connector as claimed in claim 1,
characterised in that
said plug body (10) and said connection body (20) can be reversibly latched together by means of latching means (13, 14, 22).

7. The insulation body of a plug-in connector as claimed, in claim 1,
characterised in that
said plug body (10) and said connection body (20) can be irreversibly latched together by means of latching means (13,14,22).

8. The insulation body of a plug-in connector as claimed in claim 1,
characterised in that
the connection members (21) are at least partially realised using MID technology.

9. The insulation body of a plug-in connector as claimed in claim 1,
characterised in that
the connection body (20) has an angled shape.

10. The insulation body of a plug-in connector as claimed in claim 1,
characterised in that
the connection body (20) has a straight shape.

11. The insulation body of a plug-in connector as claimed in claim 1,
characterised in that
the contact element (11) forms on one side a frustoconical portion (11a) that can be connected to a contact element of a counter-plug and/or a socket
and on the other hand has a bifurcated contact terminal (11b), by means of which a connection element (21) of the connection body (20) can be electrically contacted.
